(19) United States
(12) Patent Application Publication
(10) Pub. No.: US 2025/0349187 A1
(43) Pub. Date: Nov. 13, 2025

(54) GAMING SYSTEM AND METHOD WITH A DYNAMICALLY-SELECTED BONUS GAME

(71) Applicant: LNW Gaming, Inc., Las Vegas, NV (US)

(72) Inventors: Ted HASE, Las Vegas, NV (US); Kyle LEIBOVITZ, Henderson, NV (US); Joshua SIEVERDING, Henderson, NV (US); Yanis TSOMBANIDIS, Las Vegas, NV (US); Emily WASIELEWSKI, Las Vegas, NV (US); Hong WEI, Henderson, NV (US)

(21) Appl. No.: 19/194,320

(22) Filed: Apr. 30, 2025

Related U.S. Application Data
(60) Provisional application No. 63/644,091, filed on May 8, 2024.

(51) Int. Cl. G07F 17/32; G07F 17/34

(52) U.S. Cl. CPC G07F 17/3267; G07F 17/34

(57) ABSTRACT

There are provided a gaming machine and method that utilize game-logic circuitry and a graphical user interface configured to present a plurality of symbol-bearing base reels and a base array. The symbols include a plurality of triggering symbol types. The plurality of base reels are repeatedly spun and stopped to land symbols from the base reels in the base array. In response to the landed symbols including one of a plurality of triggering events, a bonus game is selected based on the number of triggering symbol types contributing to the triggering event. One or more of the bonus games may also add additional pluralities of symbol bearing reels and arrays based on the number of triggering symbol types contributing to the triggering event. The triggering symbols in the bonus games may be value-bearing symbols, the values borne by the triggering symbols based on their relative frequencies in the triggering event.

### CROSS-REFERENCE TO RELATED APPLICATIONS

This patent application claims priority to U.S. Provisional Patent Application No. 63/644,091, filed on May 8, 2024, which is hereby incorporated by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2024-2025, LNW Gaming, Inc.

### FIELD OF THE INVENTION

The present invention relates to a technological improvement to gaming systems, gaming machines, and methods and, more particularly, to technological improvements in connection with a multi-level feature.

### BACKGROUND OF THE INVENTION

The gaming industry depends upon player participation. Players are generally “hopeful” players who either think they are lucky or at least think they can get lucky—for a relatively small investment to play a game, they can get a disproportionately large return. To create this feeling of luck, a gaming apparatus relies upon an internal or external random element generator to generate one or more random elements such as random numbers. The gaming apparatus determines a game outcome based, at least in part, on the one or more random elements.

A significant technical challenge is to improve the operation of gaming apparatus and games played thereon, including the manner in which they leverage the underlying random element generator, by making them yield a negative return on investment in the long run (via a high quantity and/or frequency of player/apparatus interactions) and yet random and volatile enough to make players feel they can get lucky and win in the short run. Striking the right balance between yield versus randomness and volatility to create a feeling of luck involves addressing many technical problems, some of which can be at odds with one another. This luck factor is what appeals to core players and encourages prolonged and frequent player participation. As the industry matures, the creativity and ingenuity required to improve such operation of gaming apparatus and games grows accordingly.

Another significant technical challenge is to improve the operation of gaming apparatus and games played thereon by increasing processing speed and efficiency of usage of processing and/or memory resources. To make games more entertaining and exciting, they often offer the complexities of advanced graphics and special effects, multiple game features with different game formats, and multiple random outcome determinations per feature. The game formats may, for example, include picking games, reel spins, wheel spins, and other arcade-style play mechanics. Inefficiencies in processor execution of the game software can slow down play of the game and prevent a player from playing the game at their desired pace.

Yet another significant technical challenge is to provide a new and improved level of game play that uses new and improved gaming apparatus animations. Improved animations represent improvements to the underlying technology or technical field of gaming apparatus and, at the same time, have the effect of encouraging prolonged and frequent player participation.

### SUMMARY OF THE INVENTION

There are provided a gaming machine and method that utilize game-logic circuitry and a graphical user interface configured to present a plurality of symbol-bearing base reels and a base array. The symbols include a plurality of triggering symbol types. The plurality of base reels are repeatedly spun and stopped to land symbols from the base reels in the base array. In response to the landed symbols including one of a plurality of triggering events, a bonus game is selected based on the number of triggering symbol types contributing to the triggering event. One or more of the bonus games may also add additional pluralities of symbol bearing reels and arrays based on the number of triggering symbol types contributing to the triggering event. The triggering symbols in the bonus games may be value-bearing symbols, the values borne by the triggering symbols based on their relative frequencies in the triggering event.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a front view of a free-standing gaming machine according to an embodiment of the present invention.

FIG. 2 is a block diagram of a gaming system according to an embodiment of the present invention.

FIG. 3 is an exemplary presentation of a base game spin outcome in accordance with one or more embodiments.

FIG. 4 is an exemplary presentation of various game symbols in accordance with one or more embodiments.

FIGS. 5A and 5B are a flow diagram for a data processing method that corresponds to instructions executed by a controller according to an embodiment of the present invention. FIG. 5A relates to a base game portion of a wagering game; FIG. 5B relates to a bonus game portion of the wagering game.

FIG. 6, FIG. 7, and FIG. 8 are exemplary presentations of bonus game spin outcomes in accordance with one or more embodiments.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

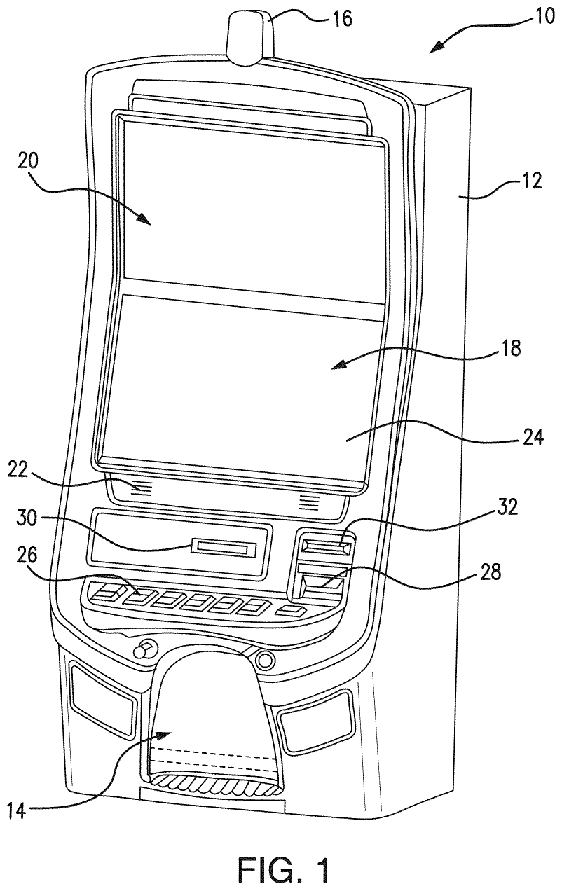

Referring to FIG. 1, there is shown a gaming machine 10 similar to those operated in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in playing wagering games, or may include non-dedicated devices, such as mobile phones, personal digital assistants, personal computers, etc. Exemplary types of gaming machines are disclosed in U.S. Pat. Nos. 6,517,433, 8,057,303, and 8,226,459, which are incorporated herein by reference in their entireties.

The gaming machine 10 illustrated in FIG. 1 comprises a gaming cabinet 12 that securely houses various input devices, output devices, input/output devices, internal electronic/electromechanical components, and wiring. The cabinet 12 includes exterior walls, interior walls, and shelves for mounting the internal components and managing the wiring, and one or more front doors that are locked and require a physical or electronic key to gain access to the interior compartment of the cabinet 12 behind the locked door. The cabinet 12 forms an alcove 14 configured to store one or more beverages or personal items of a player. A notification mechanism 16, such as a candle or tower light, is mounted to the top of the cabinet 12. It flashes to alert an attendant that change is needed, a hand pay is requested, or there is a potential problem with the gaming machine 10.

The input devices, output devices, and input/output devices, which together provide a graphical user interface (GUI), are disposed on, and securely coupled to, the cabinet 12. By way of example, the output devices include a primary presentation device 18, a secondary presentation device 20, and one or more audio speakers 22. The primary presentation device 18 or the secondary presentation device 20 may be a mechanical-reel display device, a video display device, or a combination thereof. In one such combination disclosed in U.S. Pat. No. 6,517,433, a transmissive video display is disposed in front of the mechanical reel display to portray a video image superimposed upon electro-mechanical reels. In another combination disclosed in U.S. Pat. No. 7,654,899, a projector projects video images onto stationary or moving surfaces. In yet another combination disclosed in U.S. Pat. No. 7,452,276, miniature video displays are mounted to electro-mechanical reels and portray video symbols for the game. In a further combination disclosed in U.S. Pat. No. 8,591,330, flexible displays such as OLED or e-paper displays are affixed to electro-mechanical reels. The aforementioned U.S. Pat. Nos. 6,517,433, 7,654,899, 7,452,276, and 8,591,330 are incorporated herein by reference in their entireties.

The presentation devices 18, 20, the audio speakers 22, lighting assemblies, and/or other devices associated with presentation are collectively referred to as a “presentation assembly” of the gaming machine 10. The presentation assembly may include one presentation device (e.g., the primary presentation device 18), some of the presentation devices of the gaming machine 10, or all of the presentation devices of the gaming machine 10. The presentation assembly may be configured to present a unified presentation sequence formed by visual, audio, tactile, and/or other suitable presentation means, or the devices of the presentation assembly may be configured to present respective presentation sequences or respective information.

The presentation assembly, and more particularly the primary presentation device 18 and/or the secondary presentation device 20, variously presents information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 may include a touch screen(s) 24 mounted over the primary or secondary presentation devices, buttons 26 on a button panel, a bill/ticket acceptor 28, a card reader/writer 30, a ticket dispenser 32, and player-accessible ports (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

The player input devices, such as the touch screen 24, buttons 26, a mouse, a joystick, a gesture-sensing device, a voice-recognition device, and a virtual-input device, accept player inputs and transform the player inputs to electronic data signals indicative of the player inputs, which correspond to an enabled feature for such inputs at a time of activation (e.g., pressing a “Max Bet” button or soft key to indicate a player's desire to place a maximum wager to play the wagering game). The inputs, once transformed into electronic data signals, are output to game-logic circuitry for processing. The electronic data signals are selected from a group consisting essentially of an electrical current, an electrical voltage, an electrical charge, an optical signal, an optical element, a magnetic signal, and a magnetic element.

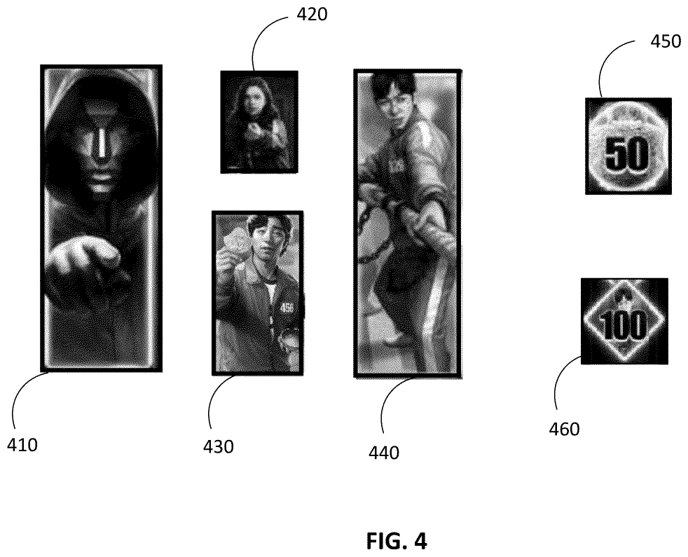

The gaming machine 10 includes one or more value input/payment devices and value output/payout devices. In order to deposit cash or credits onto the gaming machine 10, the value input devices are configured to detect a physical item associated with a monetary value that establishes a credit balance on a credit meter such as the “credits” meter 200 (see FIG. 4). The physical item may, for example, be currency bills, coins, tickets, vouchers, coupons, cards, and/or computer-readable storage mediums. The deposited cash or credits are used to fund wagers placed on the wagering game played via the gaming machine 10. Examples of value input devices include, but are not limited to, a coin acceptor, the bill/ticket acceptor 28, the card reader/writer 30, a wireless communication interface for reading cash or credit data from a nearby mobile device, and a network interface for withdrawing cash or credits from a remote account via an electronic funds transfer. In response to a cashout input that initiates a payout from the credit balance on the “credits” meter 200 (see FIG. 4), the value output devices are used to dispense cash or credits from the gaming machine 10. The credits may be exchanged for cash at, for example, a cashier or redemption station. Examples of value output devices include, but are not limited to, a coin hopper for dispensing coins or tokens, a bill dispenser, the card reader/writer 30, the ticket dispenser 32 for printing tickets redeemable for cash or credits, a wireless communication interface for transmitting cash or credit data to a nearby mobile device, and a network interface for depositing cash or credits to a remote account via an electronic funds transfer.

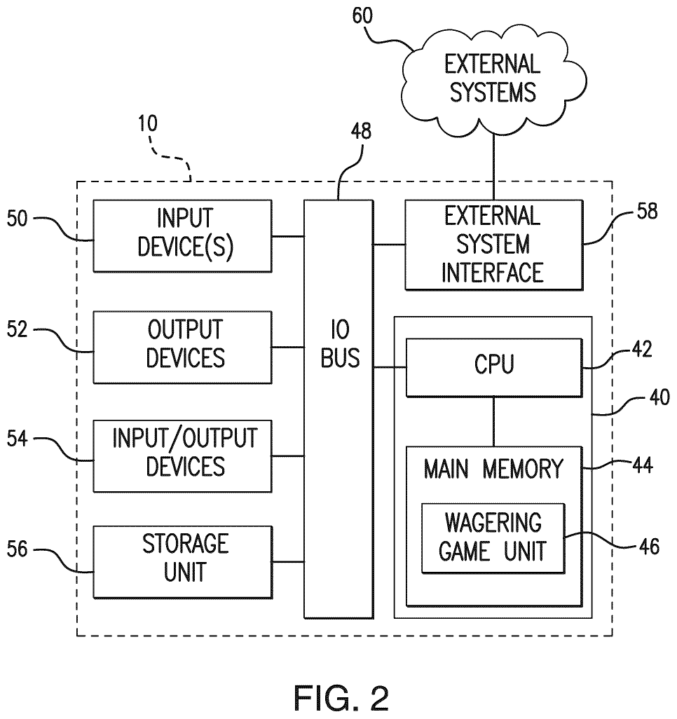

Turning now to FIG. 2, there is shown a block diagram of the gaming-machine architecture. The gaming machine 10 includes game-logic circuitry 40 securely housed within a locked box inside the gaming cabinet 12 (see FIG. 1). The game-logic circuitry 40 includes a central processing unit (CPU) 42 connected to a main memory 44 that comprises one or more memory devices. The CPU 42 includes any suitable processor(s), such as those made by Intel and AMD. By way of example, the CPU 42 includes a plurality of microprocessors including a master processor, a slave processor, and a secondary or parallel processor. Game-logic circuitry 40, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 40, and more specifically the CPU 42, comprises one or more controllers or processors and such one or more controllers or processors need not be disposed proximal to one another and may be located in different devices or in different locations. The game-logic circuitry 40, and more specifically the main memory 44, comprises one or more memory devices which need not be disposed proximal to one another and may be located in different devices or in different locations. The game-logic circuitry 40 is operable to execute all of the various gaming methods and other processes disclosed herein. The main memory 44 includes a wagering-game unit 46. In one embodiment, the wagering-game unit 46 causes wagering games to be presented, such as video poker, video blackjack, video slots, video lottery, etc., in whole or part.

The game-logic circuitry 40 is also connected to an input/output (I/O) bus 48, which can include any suitable bus technologies, such as an AGTL+ frontside bus and a PCI backside bus. The I/O bus 48 is connected to various input devices 50, output devices 52, and input/output devices 54 such as those discussed above in connection with FIG. 1. The I/O bus 48 is also connected to a storage unit 56 and an external-system interface 58, which is connected to external system(s) 60 (e.g., wagering-game networks).

The external system 60 includes, in various aspects, a gaming network, other gaming machines or terminals, a gaming server, a remote controller, communications hardware, or a variety of other interfaced systems or components, in any combination. In yet other aspects, the external system 60 comprises a player's portable electronic device (e.g., cellular phone, electronic wallet, etc.) and the external-system interface 58 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 60 such that the gaming machine 10 operates as a thin, thick, or intermediate client. The game-logic circuitry 40—whether located within (“thick client”), external to (“thin client”), or distributed both within and external to (“intermediate client”) the gaming machine 10—is utilized to provide a wagering game on the gaming machine 10. In general, the main memory 44 stores programming for a random number generator (RNG), game-outcome logic, and game assets (e.g., art, sound, etc.)—all of which obtained regulatory approval from a gaming control board or commission and are verified by a trusted authentication program in the main memory 44 prior to game execution. The authentication program generates a live authentication code (e.g., digital signature or hash) from the memory contents and compare it to a trusted code stored in the main memory 44. If the codes match, authentication is deemed a success and the game is permitted to execute. If, however, the codes do not match, authentication is deemed a failure that must be corrected prior to game execution. Without this predictable and repeatable authentication, the gaming machine 10, external system 60, or both are not allowed to perform or execute the RNG programming or game-outcome logic in a regulatory-approved manner and are therefore unacceptable for commercial use. In other words, through the use of the authentication program, the game-logic circuitry facilitates operation of the game in a way that a person making calculations or computations could not.

When a wagering-game instance is executed, the CPU 42 (comprising one or more processors or controllers) executes the RNG programming to generate one or more pseudo-random numbers. The pseudo-random numbers are divided into different ranges, and each range is associated with a respective game outcome. Accordingly, the pseudo-random numbers are utilized by the CPU 42 when executing the game-outcome logic to determine a resultant outcome for that instance of the wagering game. The resultant outcome is then presented to a player of the gaming machine 10 by accessing the associated game assets, required for the resultant outcome, from the main memory 44. The CPU 42 causes the game assets to be presented to the player as outputs from the gaming machine 10 (e.g., audio and video presentations). Instead of a pseudo-RNG, the game outcome may be derived from random numbers generated by a physical RNG that measures some physical phenomenon that is expected to be random and then compensates for possible biases in the measurement process. Whether the RNG is a pseudo-RNG or physical RNG, the RNG uses a seeding process that relies upon an unpredictable factor (e.g., human interaction of turning a key) and cycles continuously in the background between games and during game play at a speed that cannot be timed by the player. Accordingly, the RNG cannot be carried out manually by a human and is integral to operating the game.

The gaming machine 10 may be used to play central determination games, such as electronic pull-tab and bingo games. In an electronic pull-tab game, the RNG is used to randomize the distribution of outcomes in a pool and/or to select which outcome is drawn from the pool of outcomes when the player requests to play the game. In an electronic bingo game, the RNG is used to randomly draw numbers that players match against numbers printed on their electronic bingo card.

The gaming machine 10 may include additional peripheral devices or more than one of each component shown in FIG. 2. Any component of the gaming-machine architecture includes hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

In accordance with various methods of conducting a wagering game on a gaming system in accord with the present concepts, the wagering game includes a game sequence in which a player makes a wager, and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary presentation device 18 or secondary presentation device 20) through the presentation of information such as, but not limited to, text, graphics, static images, moving images, etc., or any combination thereof. In accord with the method of conducting the wagering game, the game-logic circuitry 40 transforms a physical player input, such as a player's pressing of a “Spin” touch key or button, into an electronic data signal indicative of an instruction relating to the wagering game (e.g., an electronic data signal bearing data on a wager amount).

In the aforementioned method, for each data signal, the game-logic circuitry 40 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 42 causes the recording of a digital representation of the wager in one or more storage media (e.g., storage unit 56), the CPU 42, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM, etc.). The noted second state of the data storage media comprises storage in the storage media of data representing the electronic data signal from the CPU 42 (e.g., the wager in the present example). As another example, the CPU 42 further, in accord with the execution of the stored instructions relating to the wagering game, causes the primary presentation device 18, other presentation device, or other output device (e.g., speakers, lights, communication device, etc.) to change from a first state to at least a second state, wherein the second state of the primary presentation device comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 40 to determine the outcome of the wagering-game instance. In at least some aspects, the game-logic circuitry 40 is configured to determine an outcome of the wagering-game instance at least partially in response to the random parameter.

In one embodiment, the gaming machine 10 and, additionally or alternatively, the external system 60 (e.g., a gaming server), means gaming equipment that meets the hardware and software requirements for fairness, security, and predictability as established by at least one state's gaming control board or commission. Prior to commercial deployment, the gaming machine 10, the external system 60, or both and the casino wagering game played thereon may need to satisfy minimum technical standards and require regulatory approval from a gaming control board or commission (e.g., the Nevada Gaming Commission, Alderney Gambling Control Commission, National Indian Gaming Commission, etc.) charged with regulating casino and other types of gaming in a defined geographical area, such as a state. By way of non-limiting example, a gaming machine in Nevada means a device as set forth in NRS 463.0155, 463.0191, and all other relevant provisions of the Nevada Gaming Control Act, and the gaming machine cannot be deployed for play in Nevada unless it meets the minimum standards set forth in, for example, Technical Standards 1 and 2 and Regulations 5 and 14 issued pursuant to the Nevada Gaming Control Act. Additionally, the gaming machine and the casino wagering game must be approved by the commission pursuant to various provisions in Regulation 14. Comparable statutes, regulations, and technical standards exist in or are used in other gaming jurisdictions, including for example GLI Standard #11 of Gaming Laboratories International (which defines a gaming device in Section 1.5) and N.J.S.A 5:12-23, 5:12-45, and all other relevant provisions of the New Jersey Casino Control Act. As can be seen from the description herein, the gaming machine 10 may be regulatorily approved and thus implemented with hardware and software architectures, circuitry, and other special features that differentiate it from general-purpose computers (e.g., desktop PCs, laptops, and tablets).

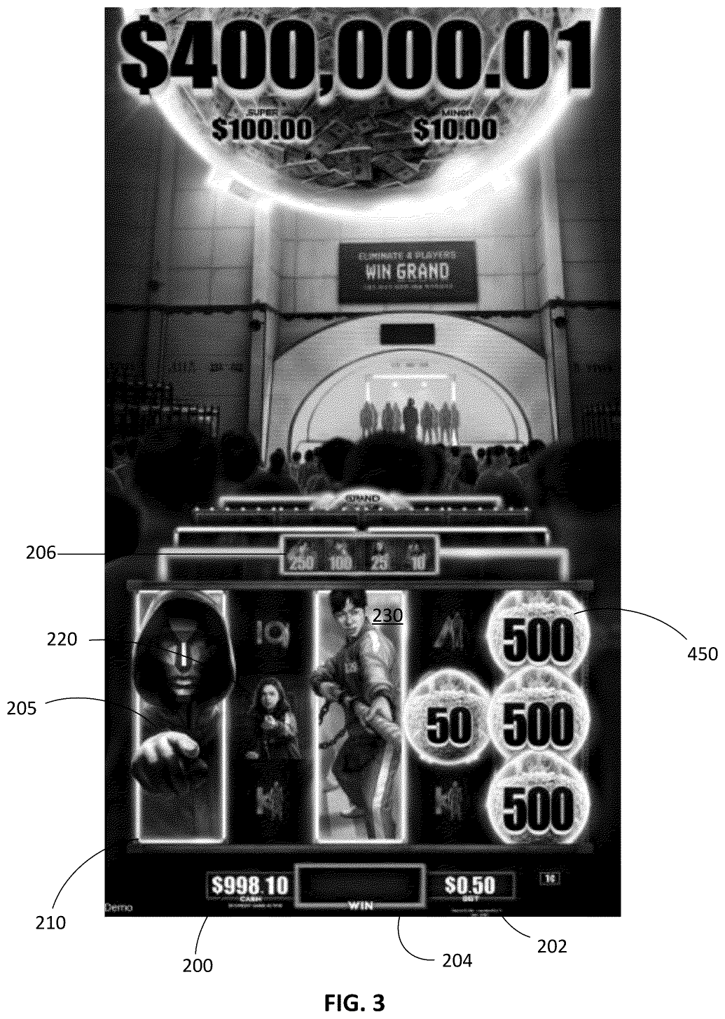

FIG. 3 represents the outcome of a representative first game spin of a base game in accordance with one or more embodiments. The game-logic circuitry, via the presentation assembly of the graphical user interface, presents a plurality of symbol-bearing base reels and a base array. In the exemplar game, the plurality of base reels are repeatedly spun and stopped to land symbols from the base reels in the base array to produce various base game outcomes.

Although the method is described with respect to one presentation device, it is to be understood that the presentation described herein may be performed by a presentation assembly including more than one presentation device. The symbol positions of the array may be arranged in a variety of configurations, formats, or structures and may comprise a plurality of rows and columns. The rows of the array are oriented in a generally horizontal direction, and the columns of the array are oriented in a generally vertical direction. The symbol positions in each row of the array are horizontally aligned with each other, and the symbol positions in each column of the array are vertically aligned with each other. Alternatively, the symbol positions may be arranged in a honeycomb configuration with adjacent columns vertically offset from each other by one-half symbol position or adjacent rows horizontally offset from each other by one-half symbol position. The number of symbol positions in different rows and/or different columns may vary from each other. The reels may be associated with the respective columns of the array such that the reels spin vertically, and each reel populates a respective column. In another embodiment, the reels may be associated with the respective rows of the array such that the reels spin horizontally, and each reel populates a respective row. In some embodiments, the reels are associated with respective individual symbol positions of the array such that each reel animates in place and populates only its respective symbol position. The symbol array configuration may vary between the base game and any bonus games utilizing the array.

In FIG. 3, the symbol array 210 in the base game has a three-by-five rectangular configuration. The reels bear a plurality of symbols that may, for example, include various standard game symbols such as stylized 10, J, Q, K, A (10, K and A are shown), a special PIG symbol (FIG. 4, 450), a catalyst symbol (FIG. 4, 410) and a plurality of triggering symbols, examples of which are illustrated in FIG. 4 as various human characters (FIG. 4, 420, 430, 440). Any uniquely identifiable symbols may be used as triggering symbols. To distinguish one triggering symbol from another in this disclosure, each uniquely identifiable trigger symbol will be referred to as a “type” of triggering symbol.

When same symbols appear adjacent to one another in a column, they may be represented as a single “stacked” symbol. For example, in the first column, a stacked symbol 230 indicates that three of the same single symbols landed in each of the rows of the first column. In FIG. 4, elements 420, 450 and 460 represent single-high symbols, element 430 indicates a two-high stacked symbol and elements 410 and 440 represent three-high stacked symbols. Though symbols appearing adjacent to one another in a column may be shown as a stack, each location in the array is still treated individually for win evaluation purposes (described below).

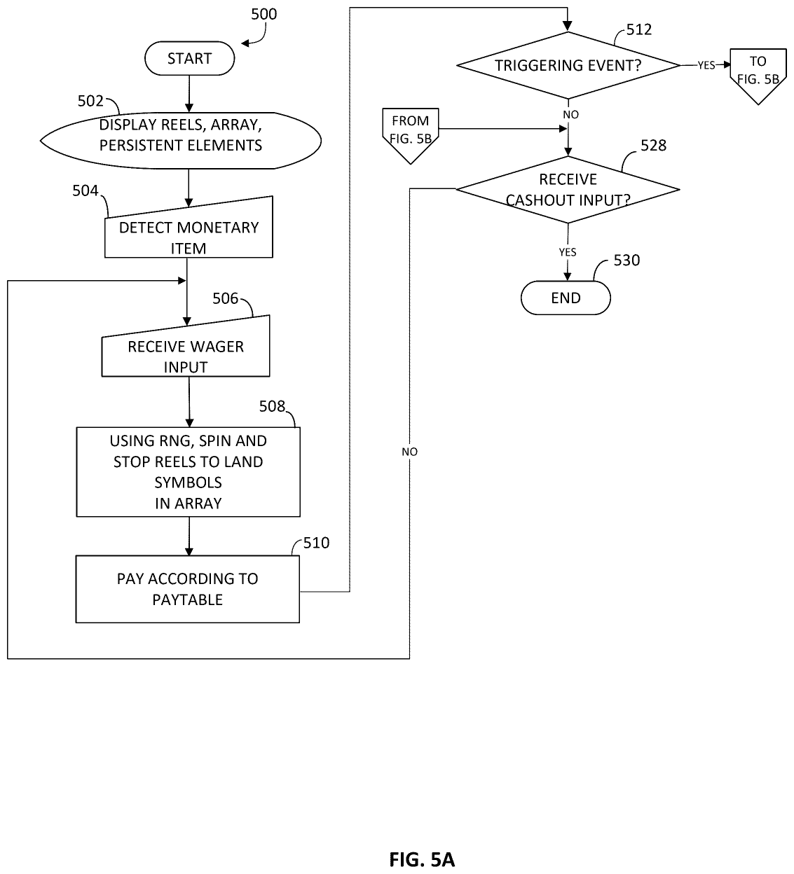

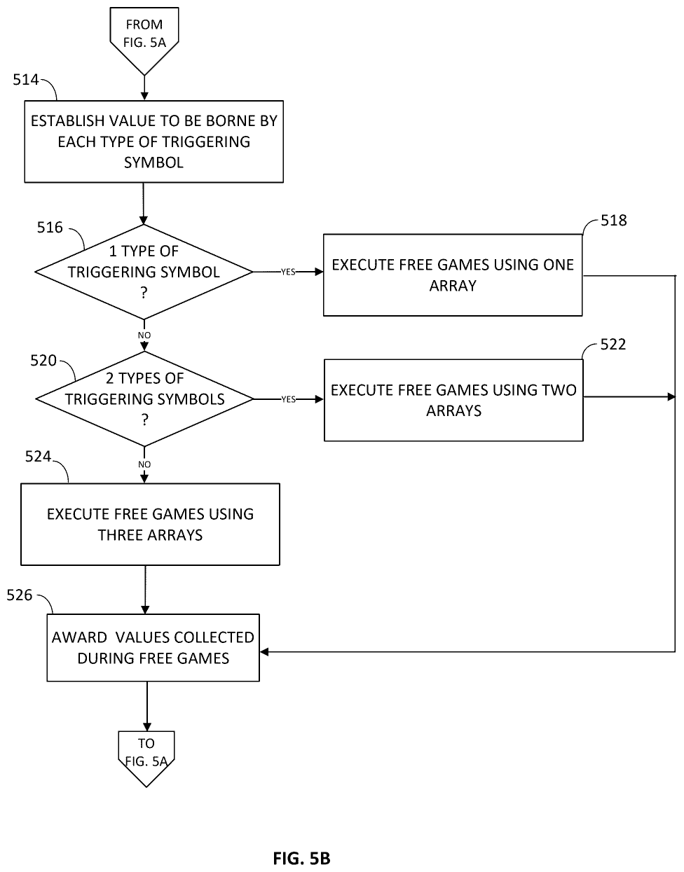

Referring now to FIGS. 5A and 5B, there is shown a flow diagram representing one data processing method corresponding to at least some instructions stored and executed by the game-logic circuitry 40 in FIG. 2 to perform operations according to embodiments of the present invention. The data processing method is described below in connection with the exemplary presentations of different spin outcomes described above in FIGS. 3 and 6-8.

### Game Play Initiation

Referring to FIG. 5A, the data processing method commences at step 500. At step 502, the game-logic circuitry controls one or more presentation devices (e.g., mechanical-reel display device, video display device, or a combination thereof) of the graphical user interface to present a plurality of symbol-bearing reels and an array 210 (FIG. 3) of symbol positions.

At step 504, the game-logic circuitry detects, via a value input device, a physical item associated with a monetary value that establishes a monetary balance in the form of cash or credits. The monetary balance may be shown on a meter 200 (FIG. 3).

### Base Game Spin

At step 506, the game-logic circuitry initiates a base game of a wagering game cycle (i.e., spin cycle) in response to an input indicative of a wager covered by the monetary balance. To initiate a spin of the reels, the player may press a “Spin” or “Max Bet” key on a button panel or touch screen. The wager may be shown on a bet meter 202 (FIG. 3).

At step 508, using the RNG, the game-logic circuitry spins and stops the reels to randomly land symbols from the reels in the array in visual association with one or ways. The reel spin may be animated on the presentation device(s) by depicting symbol-bearing strips moving vertically across the display and synchronously updating the symbols visible on each strip as the strip moves across the display. As noted above, FIG. 3 depicts an example of a base-game spin outcome.

### Base Game Win Evaluation

At step 510, the game-logic circuitry evaluates the patterns of symbols landed in the array. Payouts are awarded in accordance with a pay table. The pay table may, for example, include “ways pays,” “line pays” and “scatter pays,” all well-known to those skilled in the art. The non-limiting examples herein assume a pay table based on ways pays. Briefly, ways pays appear on adjacent reels without the requirement to be on a specified pay line or directly adjacent to one another. For example, a three by five symbol array has 243 (i.e., 35) ways to win. In a 243 ways slot machine, any combination of three or more matching symbols can be a win, provided they appear anywhere on adjacent reels, starting from the first reel and going left to right. Only one instance of a symbol on a reel is included in a given winning combination. Thus, the best combination is a five of a kind. However, each winning combination is multiplied by the number of ways it occurs from left to right, so it is advantageous to have more than one instance of a given symbol on a reel.

In some embodiments, a multiplier may also appear on certain symbols, for example, PIG symbols, and affect the number of ways. (A PIG x2 represents “a stack of two PIGS”.)

| | | | | |
|---|---|---|---|---|
| | | | | Pig |
| Pig | Pig | Pig | Pig x2 | |
| | Pig x2 | | | |

In the example above, the result is 1 way on reel 1, 2+1=3 ways on reel 2, 1 way on reel 3, 2 ways on reel 4, and 1 way on reel 5. The ways on each of the reels is then summed. Total ways to get a PIG Five of a Kind=1×3×1×2×1=6 ways. If a single PIG Five-of-a-Kind pays 200 credits, according to the pay table, the resulting pay in this example would be 6 Ways×200 credits=1200 credits.

To animate a winning combination, the display may apply a border, pattern, color change, background change, watermark, or other distinguishing characteristic to the winning winning symbols that contributed to the pay. Each awarded pay is added to a win meter 204 (FIG. 3).

### Entering Bonus Game Mode

At step 512, the game-logic circuitry determines whether or not a bonus game triggering event occurred. If not, flow continues at step 528 (described below), otherwise flow continues to step 514 on FIG. 5B. For the sake of this example, it is assumed that a triggering event occurs at step 512.

In the embodiments described here, three possible triggering events are possible, each initiating a different bonus game. The bonus games include a series of free spins of special bonus reels bearing a plurality of standard symbols, human character symbols, and PIG symbols which may be the same as the symbols of the base game or different. In these examples, the bonus game symbols are the same as the base game symbols, though they may function differently in the bonus games, as described below.

Regardless of which bonus game is triggered, a series of free spins of the bonus reels are executed by the game-logic circuitry. Typically, a spin counter will be initialized at the start of the bonus game, for example, at step 514, described further below. The spin counter may be a same predetermined value in each bonus game, may be randomly determined via the RNG at the start of each bonus game, or may be based on some outcome of the base game that triggered the bonus game. For example, the number of free spins may be based on how many triggering symbols contributed to the triggering event. One or more arrays including symbol-bearing bonus reels are presented on the presentation devices. The game-logic circuitry may enhance the introduction of additional arrays and pluralities of reels with complex animations via the one or more presentation devices. For each free spin of the bonus game, the bonus reels are animated to spin and stop, landing symbols in the one or more arrays in a manner similar to that of step 508.

In the bonus game examples described here, the triggering symbols are converted to value-bearing symbols, otherwise known as WYSIWYG (“What You See is What You Get”) or “cash on reels” symbols. Each value-bearing symbol is associated with a credit or currency value indicated on the symbol itself. In one or more embodiments, a value-bearing symbol may be associated with a value determined or displayed separately. For example, rather than a specific amount, a MINI, MINOR, MAJOR or GRAND award label associated with a progressive or non-progressive jackpot may be indicated on a value-bearing symbol.

At the end of each bonus spin, combinations of landed standard symbols may or may not be evaluated against a pay table, as described above in regard to step 510. Values borne by any landed value-bearing symbols are tallied and added to a running total. As each bonus spin is completed, the spin counter is decremented. Some events, for example, the landing of certain symbols in the array, may add additional spins to the spin counter during the bonus game, prolonging free play. Free spins continue until the spin counter reaches zero, at which time the bonus game concludes. The bonus game may be a “hold and spin” bonus game in which certain symbols, for example value-bearing symbols, are held in place in the array, in which case the values borne by these symbols are added to the tally after each remaining free spin.

In the embodiments shown here, each triggering event includes a three-high stacked catalyst symbol and one or more types of trigger symbols landing in the array 210 at the conclusion of a base game spin. In other embodiments, no catalyst symbol is required. For example, a triggering event may simply require that a certain number of triggering symbols are present in the array 210.

The exemplar base game spin outcome of FIG. 3 illustrates a triggering condition in which the three-high stacked catalyst symbol 205 appears in the first column, a first type of triggering symbol 220 appears in the second column and a second type of triggering symbol 230 appears in the third column.

At step 514, the game-logic circuitry assigns a value to each of these types of triggering symbols. Values are not assigned to types of triggering symbols that did not appear in the triggering event. The value on each type of triggering symbol may be fixed or variable (e.g., random) from one bonus game initiation to the next. For example, a first type of triggering symbol may be assigned a value of 250 credits, a second type of triggering symbol maybe assigned a value of 100 credits, a third type of triggering symbol may be assigned a value of 25 and a fourth type of triggering symbol may be assigned a value 10. These values may be displayed in a table 206 (FIG. 3). While still visually corresponding to their appearance in the base game, the triggering symbols may be displayed with an altered appearance in the bonus games. For example, the value-bearing symbols may portray the same human characters as on their respective triggering symbols, but have a different shape (FIG. 4, 460).

In accordance with some embodiments, at step 514, the values assigned to each triggering symbol may be modified depending on their frequency of occurrence in the triggering condition. For example, in FIG. 3, the first type of triggering symbol 220 is a single high character and does not appear anywhere else in the array. Since there is only one occurrence of the type of triggering symbol, its assigned base value will not be modified. The second type of character symbol 230 is a three-high stack, thus there are three occurrences of the second type of triggering symbol contributing to the triggering condition. The value assigned to each triggering symbol of the second type in the bonus game will be modified by a factor of three. For example, this triggering symbol has a base value (as displayed in the table 206) of 100 and, thus, will be assigned a value of 300 (100×3=300) credits in the bonus game.

In these embodiments, the number of different types of triggering symbols appearing with the catalyst symbol determines which of three bonus games will be played. Typically, the more difficult it is to achieve a particular triggering event, the more lucrative the selected bonus game will be. For example, the bonus game selected when there is only one type of triggering symbol contributing to the triggering event may be played with one array and set of reels, while the bonus game selected when there are three types of triggering symbols contributing to the triggering event may offer four arrays and sets of reels. The latter offers more chances to win during the bonus game.

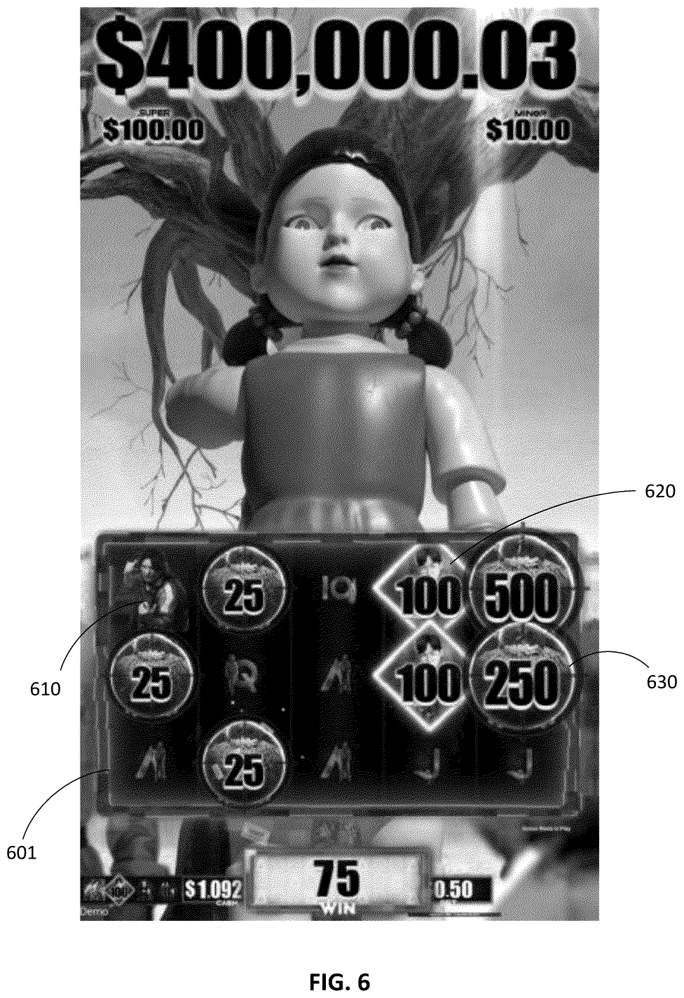

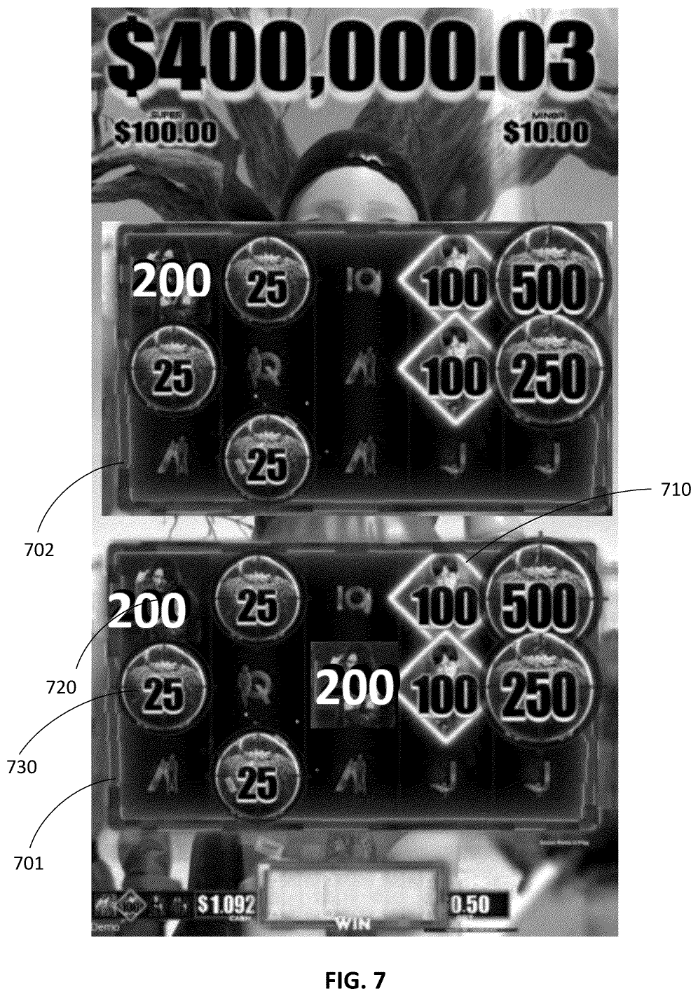

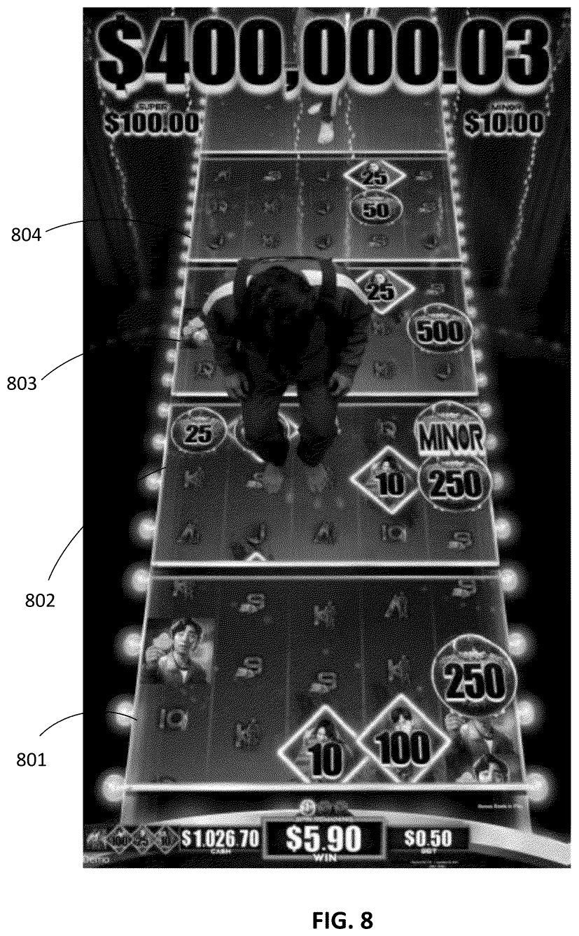

At step 516, if only one type of triggering symbol landed in the array together with the catalyst symbol, a bonus game as described above is conducted with a single array at step 518. FIG. 6 illustrates an example of the conclusion of a game spin in such a single array bonus game. In the example of FIG. 6, the triggering symbol 610 in the first column of the array did not contribute to the triggering of the bonus game and, thus, does not bear a credit value. Each triggering symbol 620, of which there are two in the fourth column, bears a credit value of 100, the base value assigned at step 512, because this triggering symbol was the only type of symbol contributing to the triggering event. When the bonus game concludes, flow continues to step 526, where the tallied outcomes of any winning combinations of standard symbols and any accumulated values from value-bearing symbols are awarded. Flow then returns to FIG. 5A at step 528.

At step 520, if two types of triggering symbols landed in the array together with the catalyst symbol, as shown in FIG. 3, a bonus game as described above is conducted at step 522. FIG. 7 illustrates an example of the conclusion of a game spin of such a bonus game. In this example, the bonus game uses two arrays 701, 702.

For simplicity's sake, assume that the two types of triggering symbols contributing to the triggering event were both assigned a base value of 100 credits at step 512.

Further assume that only one occurrence of the first type of triggering symbol 710 contributed to the triggering event. The value borne by this symbol in the arrays 701, 702 is the base value assigned at step 512.

Further assume that the second type of triggering symbol 720 contributed to the triggering event with two occurrences of the triggering symbol. All instances of this triggering symbol were upgraded to 200 credits (100 base credits x2=200 credits) at step 512.

When the bonus game concludes, flow continues to step 526, where the tallied outcomes of any winning combinations of standard symbols and any accumulated values from value-bearing symbols are awarded. Flow then returns to FIG. 5A at step 528.

At step 524, by default, three types of triggering symbols landed in the array together with the catalyst symbol. A bonus game as described above is conducted with four arrays 800, 801, 802, 803. FIG. 8 illustrates a non-limiting example of a four-array layout in accordance with such a bonus game. As described above, the values borne by each of the triggering symbols are weighted according to their respective contributions to the triggering event. When the bonus game concludes, flow continues to step 526, where the tallied outcomes of any winning combinations of standard symbols and any accumulated values from value-bearing symbols are awarded. Flow then returns to FIG. 5A at step 530.

At step 528, the game-logic circuitry determines whether or not it has received a cashout input via at least one of the one or more player input devices of the gaming machine. If it has not received a cashout input, the game-logic circuitry waits for the next wager input at step 506. If it has received a cashout input, the game-logic circuitry initiates a payout from the monetary balance on the meter 200. The data processing method then ends at step 530.

In this description, numerous specific details are set forth. However, it is understood that embodiments of the invention may be practiced without these specific details.

Variations falling within the scope of the invention may include, as shown, the introduction or replacement of various numbers of arrays from the game. While all of the arrays described above have the same 3×5 configuration, the array(s) associated with each level may vary.

In accordance with some embodiments, the bonus symbols and the base game symbols may differ. In these cases, a new paytable including the bonus symbols is also introduced for use during the bonus games.

In some embodiments, the height of a stacked character symbol affects the value borne by that symbol. For example, a two-high character stack may double the value typically borne by a single-high character, a three-high character stack may triple the value typically borne by a single-high character, etc.

The illustrated displays resulting from representative spins are not intended to show all of the frames of the animations or all possible displays or animations, only to highlight various aspects of exemplar displays and animations.

The recitations of a value input device for establishing a credit balance, an input device for accepting a wager input that initiates a spin, and a value output device for paying out the credit balance are integrally incorporated within the steps of the data processing method. For example, the presentation of game outcomes through the spinning and stopping of the reels is essential to the game outcome determinations, which may only be initiated by the accepted wager input. Furthermore, a value input device for establishing a credit balance, an input device for accepting a wager that initiates a spin, and a value output device for paying out the credit balance are physical, structural elements that are not shared by generic or well-known computing devices but, rather, are particular to gaming machines.

Embodiments of the present invention realize benefits in increased computer processing efficiency with minimized processing overhead, fewer rules to be evaluated, fewer player inputs to be monitored, and simpler graphical representations. Some embodiments of the present invention comprise an innovative application of data processing steps that, when implemented by game-logic circuitry, direct the presentation assembly of the graphical user interface to present a process that minimizes processing overhead by utilizing numbered indicia to represent credit values instead of complex, fanciful game images. In this way, the value-bearing symbols require fewer rules needed for the award process than would be necessary for calculating values of winning symbol combinations enumerated in stored paytables, as described with respect to the base symbol paytable of step 510 above. Thus, the employment of value-bearing symbols allows for the use of an abbreviated paytable, since some of the pays do not require use of a paytable at all. At the same time, embodiments of the present invention provide a straightforward, what-you-see-is-what-you-get (WYSIWYG) visual presentation that is simple to understand and, therefore, effective in generating player excitement and enthusiasm. The result is a highly flexible value-award process that can be easily adapted to any theme/brand while remaining easily understood by players.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A method of operating a gaming machine, the method comprising the operations of:
presenting a base game, via a presentation assembly of a graphical user interface, the base game comprising an array and a plurality of reels bearing a plurality of standard symbols and a plurality of types of triggering symbols;
animating, via the presentation assembly, a series of spins of the reels to randomly land selected ones of the standard symbols and the triggering symbols in the array;
in response to at least one type of triggering symbol landing in the array, animating, via the presentation assembly, initiation of a bonus game comprising at least one bonus array and a plurality of bonus reels, the number of bonus arrays and pluralities of reels based on how many types of triggering symbols landed in the array.

2. The method of claim 1, wherein at least one of the bonus games comprises a hold and spin game.

3. The method of claim 1, wherein the bonus games are free games.

4. The method of claim 1, wherein, in at least one of the bonus games, the triggering symbols are converted to value-bearing symbols.

5. The method of claim 4, wherein the value-bearing symbols bear credit amounts.

6. The method of claim 5, wherein the credit amounts are determined, at least in part, by how many of each respective triggering symbol landed in the array to trigger the bonus game.

7. The method of claim 4, wherein the value-bearing symbols comprise stacked symbols.

8. The method of claim 7 wherein values borne by the stacked symbols are based, at least in part, on the height of the stacked symbol.

9. The method of claim 4 wherein the value-bearing symbols bear jackpot identifiers.

10. The method of claim 1, wherein initiation of a bonus game requires a catalyst symbol landing in the array in addition to at least one type of triggering symbol landing in the array.

11. A gaming machine comprising:
a graphical user interface comprising a presentation assembly; and
game-logic circuitry configured to perform the operations of:
presenting a base game, by the presentation assembly, the base game comprising an array and a plurality of reels bearing a plurality of standard symbols and a plurality of types of triggering symbols;
animating, via the presentation assembly, a series of spins of the reels to randomly land selected ones of the standard symbols and the triggering symbols in the array;
in response to at least one type of triggering symbol landing in the array, animating, via the presentation assembly, initiation of a bonus game comprising at least one bonus array and a plurality of bonus reels, the number of bonus arrays and pluralities of reels based on how many types of triggering symbols landed in the array.

12. The gaming machine of claim 11, wherein at least one of the bonus games comprises a hold and spin game.

13. The gaming machine of claim 11, wherein the bonus games are free games.

14. The gaming machine of claim 11, wherein, in at least one of the bonus games, the triggering symbols are converted to value-bearing symbols.

15. The gaming machine of claim 14, wherein the value-bearing symbols bear credit amounts.

16. The gaming machine of claim 15, wherein the credit amounts are determined, at least in part, by how many of each respective triggering symbol landed in the array to trigger the bonus game.

17. The gaming machine of claim 14, wherein the value-bearing symbols comprise stacked symbols.

18. The gaming machine of claim 17 wherein values borne by the stacked symbols are based, at least in part, on the height of the stacked symbol.

19. The gaming machine of claim 14 wherein the value-bearing symbols bear jackpot identifiers.

20. The gaming machine of claim 11, wherein initiation of a bonus game requires a catalyst symbol landing in the array in addition to at least one type of triggering symbol landing in the array.
